(19) United States
(12) Patent Application Publication
(10) Pub. No.: US 2026/0228574 A1
(43) Pub. Date: Aug. 6, 2026

(54) INFORMATION PROCESSING METHOD, COMPUTER PROGRAM, AND INFORMATION PROCESSING APPARATUS

(71) Applicant: Tokyo Electron Limited, Tokyo (JP)

(72) Inventors: Hitomi OIGAWA, Sapporo City (JP); Dai KOBAYASHI, Sapporo City (JP)

(73) Assignee: Tokyo Electron Limited, Tokyo (JP)

(21) Appl. No.: 19/632,548

(22) Filed: Mar. 30, 2026

Related U.S. Application Data
(63) Continuation of application No. PCT/JP2024/035100, filed on Oct. 1, 2024.

(30) Foreign Application Priority Data
Oct. 10, 2023 (JP) 2023-175517

(51) Int. Cl. G06N 5/04

(52) U.S. Cl. CPC G06N 5/04

(57) ABSTRACT

An information processing method includes: acquiring, by an information processing apparatus, input data to a substrate processing apparatus, intermediate data measured in relation to substrate processing performed by the substrate processing apparatus based on the input data, and processing result data measured in relation to a processing result of the substrate processing; generating, by the information processing apparatus, a processing result prediction model to receive the intermediate data as an input and output a prediction value of the processing result data; estimating, by the information processing apparatus, intermediate data for improving prediction accuracy of the processing result prediction model; and estimating, by the information processing apparatus, input data for obtaining the estimated intermediate data.

### CROSS-REFERENCE TO RELATED APPLICATIONS

This application is a bypass continuation application of international application No. PCT/JP 2024/035100 having an international filing date of Oct. 1, 2024 and designating the United States, the international application being based upon and claiming the benefit of priority from Japanese Patent Application No. 2023-175517, filed on Oct. 10, 2023, the entire contents of each of which are incorporated herein by reference.

### BACKGROUND

### Field

The present disclosure relates to an information processing method, a computer program, and an information processing apparatus.

### Background Art

Patent Literature 1 proposes a system that includes a process platform, an on-board metrology tool, and a machine learning-based process control model, receives SEM metrology data, and periodically updates the process control model using a machine learning technique to cope with inter-chamber variations and control device operational variations during production.

### CITATION LIST

### Patent Documents

Patent Literature: JP2023-015270A

### SUMMARY

The present disclosure provides an information processing method, a computer program, and an information processing apparatus which can be expected to support data collection for improving accuracy of a model for predicting a processing result of a substrate processing apparatus.

An information processing method includes: acquiring, by an information processing apparatus, input data to a substrate processing apparatus, intermediate data measured in relation to substrate processing performed by the substrate processing apparatus based on the input data, and processing result data measured in relation to a processing result of the substrate processing; generating, by the information processing apparatus, a processing result prediction model to receive the intermediate data as an input and output a prediction value of the processing result data; estimating, by the information processing apparatus, intermediate data for improving prediction accuracy of the processing result prediction model; and estimating, by the information processing apparatus, input data for obtaining the estimated intermediate data.

### BRIEF DESCRIPTION OF DRAWINGS

The scope of the present disclosure is best understood from the following detailed description of exemplary embodiments when read in conjunction with the accompanying drawings.

FIG. 1 is a schematic diagram illustrating an overview of an information processing system according to the present embodiment.

FIG. 2 is a schematic diagram illustrating an example of a correspondence relationship of data acquired in the present embodiment.

FIG. 3 is a block diagram showing a configuration example of the information processing apparatus according to the present embodiment.

FIG. 4 is a schematic diagram illustrating an example of a configuration of a processing result prediction model according to the present embodiment.

FIG. 5 is a schematic diagram illustrating data estimation.

FIG. 6 is a schematic diagram illustrating an example of a configuration of an input estimation model according to the present embodiment.

FIG. 7 is a schematic diagram illustrating an example of estimation results of intermediate data and input data.

FIG. 8 is a flowchart illustrating an example of a procedure of data estimation processing performed by the information processing apparatus according to a first embodiment.

FIG. 9 is a schematic diagram illustrating data estimation performed by the information processing apparatus according to a modification example.

FIG. 10 is a schematic diagram illustrating an example of a correspondence relationship of data acquired by an information processing system according to a second embodiment.

FIG. 11 is a schematic diagram illustrating an example of a configuration of an intermediate data estimation model according to the second embodiment.

FIG. 12 is a schematic diagram illustrating an example of estimation results of intermediate data and input data in the information processing system according to the second embodiment.

FIG. 13 is a flowchart illustrating an example of a procedure of data estimation processing performed by the information processing apparatus according to the second embodiment.

FIG. 14 is a schematic diagram illustrating an example of the correspondence relationship of data acquired by the information processing system according to a second modification example of the second embodiment.

### DETAILED DESCRIPTION

Hereinafter, a specific example of an information processing system according to the embodiment of the present disclosure will be described with reference to the drawings. The present disclosure is not limited to these examples, and is defined by the claims, and is intended to include all modifications within the meaning and scope equivalent to the claims.

### First Embodiment

### System Overview

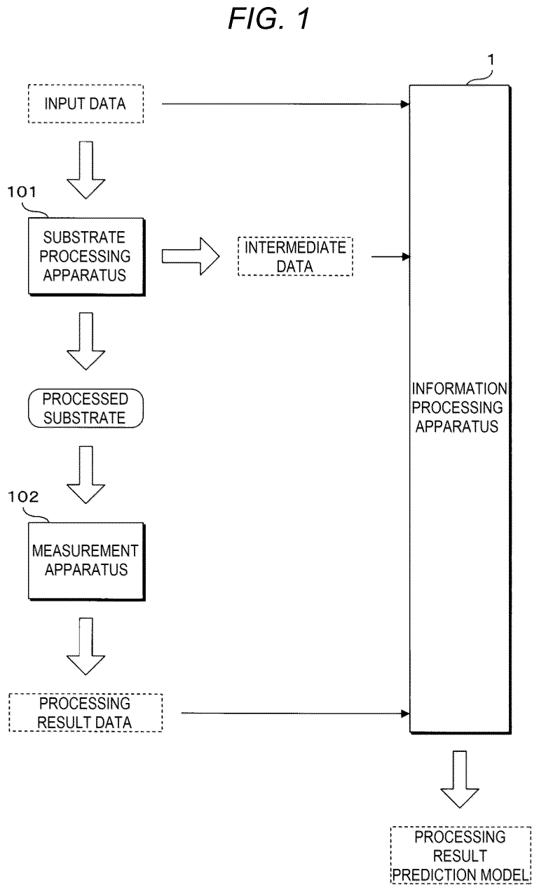

FIG. 1 is a schematic diagram illustrating an overview of an information processing system according to the present embodiment. The information processing system according to the present embodiment includes an information processing apparatus 1, a substrate processing apparatus 101, a measurement apparatus 102, and the like. The substrate processing apparatus 101 is an apparatus such as a process chamber that performs substrate processing such as etching on a substrate such as a semiconductor wafer. The substrate processing apparatus 101 receives, from a user, for example, an input of input data such as recipe parameters, and performs substrate processing such as etching based on values set in the input data. In the present embodiment, the input data includes one or a plurality of values that can be set by the user.

The substrate processing apparatus 101 has various sensors that measure an internal state of the apparatus, a state of a target substrate, or the like in a process of performing the substrate processing on a target substrate. The sensors in the substrate processing apparatus 101 may include various sensors such as a sensor that measures a temperature, a sensor that measures a voltage, and a sensor that measures a pressure. In the present embodiment, data detected by these sensors along with the performance of substrate processing will be referred to as intermediate data.

The measurement apparatus 102 measures values indicative of performance, quality, or the like, of substrates subjected to the substrate processing by the substrate processing apparatus 101. For example, the measurement apparatus 102 measures a length, a size, or the like of a pattern formed on a surface of the substrate, based on an image obtained by capturing an image of the surface of the substrate. For example, the measurement apparatus 102 may be implemented to perform measurement using a laser, an ultrasonic wave, or the like, or may be implemented to perform measurement of the substrate by any methods, or may be implemented to use spectral analysis such as emission spectroscopy. Values measured by the measurement apparatus 102 is not limited to the length, the size, or the like, and may be, for example, various values such as electric characteristics or a concentration of a predetermined element in a film (herein “film” means the same as “layer”). A value measured by the measurement apparatus 102 may be any value as long as the value relates to the performance, the quality, or the like of a substrate subjected to the substrate processing by the substrate processing apparatus 101. In the present embodiment, data obtained through measurements performed by the measurement apparatus 102 will be referred to as processing result data. However, when data obtained through measurements performed by the measurement apparatus 102 is used for the generation of a processing result prediction model, such as when a composition ratio of components included in the substrate is used for a prediction model of a k value (dielectric constant) of the substrate, these pieces of data may be treated as the intermediate data instead of the processing result data. The measurement apparatus 102 may be disposed in the vicinity of the substrate processing apparatus 101 as, for example, an apparatus separate from the substrate processing apparatus 101, or may be provided as, for example, an apparatus integrated with the substrate processing apparatus 101 (herein “disposed” means the same as “located”).

The information processing apparatus 1 performs processing to collect data related to the substrate processing performed by the substrate processing apparatus 101, and processing to generate a processing result prediction model that predicts a result of the substrate processing based on the collected data. The information processing apparatus 1 may be implemented by using, for example, a general-purpose personal computer or a server computer, or a dedicated controller or the like. In the present embodiment, the information processing apparatus 1 acquires and stores input data to the substrate processing apparatus 101, intermediate data detected by a sensor of the substrate processing apparatus 101, and processing result data detected by the measurement apparatus 102. The information processing apparatus 1 performs machine learning based on, for example, the intermediate data and the processing result data to generate a processing result prediction model that receives the intermediate data as an input and outputs a prediction value of the processing result data.

In the present embodiment, when prediction accuracy based on the generated processing result prediction model is insufficient, the information processing apparatus 1 estimates what kind of data (input data and/or intermediate data) is preferred for improving the prediction accuracy, and provides an estimation result to the user. The user inputs the input data estimated by the information processing apparatus 1 into the substrate processing apparatus 101, and causes the substrate processing apparatus 101 to perform the substrate processing, so that the intermediate data and the processing result data can be additionally obtained. The information processing apparatus 1 stores the input data, the intermediate data, and the processing result data that are additionally obtained, and regenerates or updates the processing result prediction model using these pieces of data, so that it is expected to improve the prediction accuracy of the processing result prediction model.

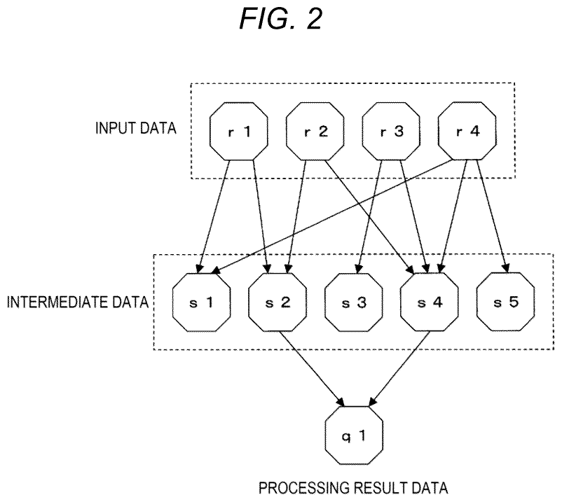

FIG. 2 is a schematic diagram illustrating an example of a correspondence relationship of data acquired in the present embodiment. In the illustrated example, for example, the input data includes four values r1 to r4, the intermediate data includes five values s1 to s5, and the processing result data includes one value of q1. The input data r1 to r4 are values that can be set by the user as recipe parameters for the substrate processing apparatus 101, and may be, for example, a temperature inside a chamber, a pressure inside the chamber, a flow rate of a gas, and a holding time of a gas. The intermediate data s1 to s5 are values measured by a sensor during the substrate processing, and may be, for example, measured values of a current, plasma emission, or an impedance during processing in a chamber. Processing result data Q1 is a measured value obtained by performing measurement on the substrate subjected to the substrate processing by the measurement apparatus 102, and may be, for example, an etching rate.

In the present example, it is previously found that the intermediate data s1 is a value determined by the input data r1 and r4, the intermediate data s2 is a value determined by the input data r1 and r2, the intermediate data s3 is a value determined by the input data r3, the intermediate data s4 is a value determined by the input data r2, r3, and r4, and the intermediate data s5 is a value determined by the input data r4. In the present example, it is found in advance that the processing result data q1 is a value determined by the intermediate data s2 and s4. Information related to a correspondence relationship between these pieces of data is input in advance by the user to the information processing apparatus 1, for example.

In the present embodiment, the information processing apparatus 1 receives, for example, the intermediate data s2 and s4 as inputs based on data obtained by the substrate processing performed by the substrate processing apparatus 101, and generates a processing result prediction model that predicts the processing result data q1. In order to generate a processing result prediction model having high prediction accuracy, it is preferable to use as many pieces of data as possible and as various kinds of data as possible for generation. Factors such as a small amount of data to be used for generation or a bias may cause a decrease in the prediction accuracy of the processing result prediction model. When the prediction accuracy of the generated processing result prediction model is low, the accuracy of the processing result prediction model may be expected to be improved by performing additional data collection to regenerate or update the processing result prediction model.

The information processing apparatus 1 estimates what combination of the intermediate data s2 and s4 is necessary to improve the prediction accuracy of the processing result data q1 based on the processing result prediction model. The information processing apparatus 1 can estimate the intermediate data s2 and s4 based on, for example, a design of experiments (DOE). The design of experiments is a method of planning what kind of experiment is most efficient in order to clarify a relationship between the input and the output. The design of experiments includes various methods such as an optimal design method, a space filling method, a random arrangement, a screening design method, a factor design method, a response surface design method, a Taguchi design method, a mixture design method, and Bayesian optimization, and the information processing apparatus 1 may estimate the intermediate data s2 and s4 by using any of these methods. By performing the substrate processing with the intermediate data s2 and s4 estimated by the design of experiments to obtain the processing result data q1, additional data for generating a processing result prediction model with higher accuracy can be expected.

As described above, the intermediate data s2 and s4 are data measured by the sensor of the substrate processing apparatus 101, and are not data that can be set by the user. The input data r1 to r4 can be set by the user. However, it is not easy for the user to determine the values of the input data r1 to r4 in order to set the intermediate data s2 and s4 to desired values. Therefore, the information processing apparatus 1 according to the present embodiment further estimates the values of the input data r1 to r4 for implementing the intermediate data s2 and s4 estimated based on the design of experiments, and provides the estimation results to the user.

### Apparatus Configuration

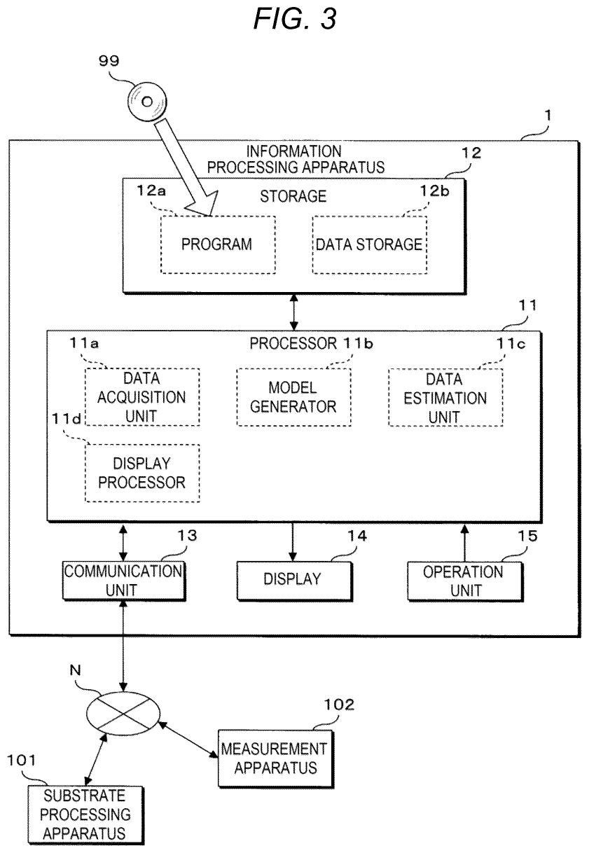

FIG. 3 is a block diagram showing a configuration example of the information processing apparatus 1 according to the present embodiment. The information processing apparatus 1 according to the present embodiment can be implemented by installing a given application program or the like in a general-purpose information processing apparatus such as a personal computer or a server computer. The information processing apparatus 1 may be a dedicated information processing apparatus that controls the substrate processing apparatus 101. The information processing apparatus 1 according to the present embodiment includes a processor 11 (herein “processor” means the same as “controller circuitry”), a storage 12, a communication unit 13, a display 14, an operation unit 15, and the like. In the present embodiment, an example will be described in which a process is performed by one information processing apparatus 1. Meanwhile, the process of the information processing apparatus 1 may be distributed and performed by a plurality of apparatuses (herein “unit” means the same as “circuitry”).

The processor 11 is configured by using an arithmetic processing apparatus such as a central processing unit (CPU), a micro-processing unit (MPU), a graphics processing unit (GPU), or a quantum processor, a read only memory (ROM), a random access memory (RAM), and the like. The processor 11 reads and executes a program 12a stored in the storage 12, thereby performing various kinds of processing such as processing for acquiring the input data, the intermediate data, and the processing result data related to the substrate processing performed by the substrate processing apparatus 101, processing for generating the processing result prediction model based on the acquired data, and processing for estimating data that improves the prediction accuracy of the processing result prediction model. The processor/controller circuitry 11 can be programmable circuitry (e.g., embedded processor) or fixed circuitry (e.g., ASIC or PAL). In an exemplary embodiment, the processor/controller circuitry 11 can include one or more programmable processors/controllers.

The storage 12 is configured by using, for example, a large-capacity storage device such as a hard disk or a solid state drive (SSD). The storage 12 stores various types of programs to be executed by the processor 11 and various types of data necessary for the process of the processor 11. In the present embodiment, the storage 12 stores the program 12a to be executed by the processor 11. The storage 12 is provided with a data storage 12b that stores and accumulates the input data, intermediate data, and the processing result data collected in connection with the substrate processing performed by the substrate processing apparatus 101.

In the present embodiment, the program (computer program, program product) 12a is provided in a form recorded on a recording medium 99 such as a memory card or an optical disc. The information processing apparatus 1 reads the program 12a from the recording medium 99, and stores the program 12a in the storage 12. However, for example, the program 12a may be written into the storage 12 during a manufacturing stage of the information processing apparatus 1. For example, as the program 12a, the information processing apparatus 1 may acquire those which are distributed by a remote server device or the like through communication. For example, the program 12a may be written into the storage 12 of the information processing apparatus 1 after a writing apparatus reads data recorded in the recording medium 99. The program 12a may be provided in the form of distribution through a network, or may be provided in the form recorded in the recording medium 99.

The data storage 12b stores the input data input by the user to the substrate processing apparatus 101, the intermediate data measured by the sensor when the substrate processing apparatus 101 performs the substrate processing based on the input data, and the processing result data obtained by measuring a result of the substrate processing by the measurement apparatus 102 in association with each other. A plurality of sets of input data, intermediate data, and processing result data acquired by the information processing apparatus 1 are stored in the data storage 12b, and preferably, as many sets of, and as diverse data as possible are stored. The information processing apparatus 1 uses these pieces of data stored in the data storage 12b to perform processing such as the generation of the processing result prediction model and the data estimation for the purpose of improving the prediction accuracy of the processing result prediction model.

The communication unit 13 transmits and receives data to and from the substrate processing apparatus 101 and the measurement apparatus 102 via a wired or wireless network N. In the present embodiment, the information processing apparatus 1 can acquire the input data and the intermediate data through communication with the substrate processing apparatus 101, and acquire the processing result data through communication with the measurement apparatus 102. The communication unit 13 receives data transmitted from the substrate processing apparatus 101 or the measurement apparatus 102, and supplies the received data to the processor 11. In the present embodiment, the substrate processing apparatus 101 and the measurement apparatus 102 transfer data to and from the information processing apparatus 1 through communication, and the present disclosure is not limited to the configuration, and data may be exchanged through a recording medium such as a memory card.

The display 14 is configured by using a liquid crystal display or the like, and displays various images, characters, and the like based on the process of the processor 11. The operation unit 15 receives a user operation and notifies the processor 11 of the received operation. For example, the operation unit 15 receives the user operation by an input device such as a mechanical button or a touch panel provided on a surface of the display 14. For example, the operation unit 15 may be an input device such as a mouse and a keyboard, and these input devices may be configured to be detachable from the information processing apparatus 1.

The storage 12 may be an external storage device connected to the information processing apparatus 1. The information processing apparatus 1 may be a multi-computer including a plurality of computers, or may be a virtual machine virtually constructed by software. In addition, the information processing apparatus 1 is not limited to the configuration described above, and does not need to include the display 14, the operation unit 15, and the like, for example.

In the information processing apparatus 1 according to the present embodiment, the processor 11 reads and executes the program 12a stored in the storage 12, so that a data acquisition unit 11a, a model generator 11b, a data estimation unit 11c, a display processor 11d, and the like are implemented in the processor 11 as software functional units. In the drawing, the functional units related to the processing for generating the processing result prediction model are illustrated as the functional units of the processor 11.

The data acquisition unit 11a acquires data necessary for generating the processing result prediction model. The data acquisition unit 11a communicates with the substrate processing apparatus 101 through the communication unit 13 to acquire the input data input to the substrate processing apparatus 101 and the intermediate data measured by a sensor during the substrate processing performed according to the input data. The data acquisition unit 11a communicates with the measurement apparatus 102 using the communication unit 13 to acquire the processing result data obtained by measuring the substrate subjected to the substrate processing by the measurement apparatus 102. The data acquisition unit 11a stores the acquired input data, the intermediate data, and the processing result data in the data storage 12b in association with each other.

The model generator 11b performs processing for generating a training model by using an appropriate method such as machine learning, based on data acquired by the data acquisition unit 11a and stored in the data storage 12b. The model generator 11b generates, based on, for example, the stored intermediate data and processing result data, a processing result prediction model that receives the intermediate data as an input and outputs a prediction value of the processing result data. In the first embodiment, the model generator 11b generates, based on, for example, the input data and the intermediate data, an input estimation model that receives the intermediate data as the input and outputs an estimated value of the input data.

The model generator 11b performs processing of generating each training model described above by performing machine learning processing using the input data, the intermediate data, and the processing result data stored in the data storage 12b. In the present embodiment, as each of the training models, for example, a training model with various configurations such as linear regression, ridge regression, lasso regression, Gaussian process regression, random forest, support vector machine, or neural network can be adopted. Each of the training models may handle time series information, and in this case, a training model having a configuration such as a recurrent neural network (RNN) or a long short term memory (LSTM) may be adopted. Since a structure of the training models and a method for generating the training model through the machine learning are existing techniques, detailed description thereof will be omitted in the present embodiment.

The data estimation unit 11c performs processing for estimating data necessary for training the processing result prediction model in order to improve the prediction accuracy of the processing result data based on the processing result prediction model generated by the model generator 11b. The data estimation unit 11c first estimates the intermediate data necessary for training the processing result prediction model for improving the estimation accuracy, based on the processing result prediction model generated by the model generator 11b and the intermediate data and the processing result data stored in the data storage 12b. At this time, for example, the data estimation unit 11c can search for a range of values that are not stored in the data storage 12b among a range of values that may be taken by the intermediate data, and estimate these values as the intermediate data necessary for improving the estimation accuracy by selecting one or more values from this range. The data estimation method is not limited to the above-described method, and an appropriate method may be adopted. In the present embodiment, the data estimation unit 11c estimates data necessary for improving the estimation accuracy based on, for example, the design of experiments. Since the data estimation method based on the design of experiments is an existing technique, a detailed description thereof will be omitted.

The data estimation unit 11c performs processing for estimating the input data from which the intermediate data can be obtained, with respect to the intermediate data estimated by the method described above. In the first embodiment, the data estimation unit 11c estimates the input data using the input estimation model generated by the model generator 11b. The data estimation unit 11c can estimate the input data corresponding to the intermediate data by inputting respective values of the intermediate data estimated to be necessary for improving the accuracy of the processing result prediction model based on the design of experiments into the input estimation model, and acquiring the estimated value of the input data output by the input estimation model.

The display processor 11d performs processing to display, on the display 14, information related to the accuracy of the processing result prediction model generated by the model generator 11b, and/or information such as the estimated values of the input data necessary for improving the prediction accuracy estimated by the data estimation unit 11c.

### Data Estimation Processing

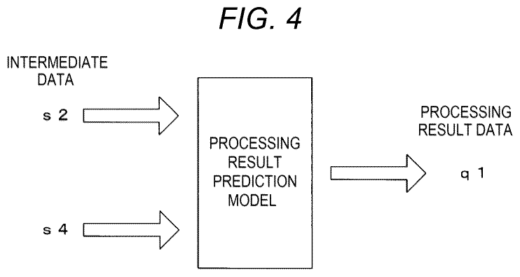

FIG. 4 is a schematic diagram illustrating an example of a configuration of the processing result prediction model according to the present embodiment. The information processing apparatus 1 according to the present embodiment generates a processing result prediction model based on the intermediate data and the processing result data acquired from the substrate processing apparatus 101 and the measurement apparatus 102. The illustrated processing result prediction model is generated by the information processing apparatus 1 by receiving the intermediate data s2 and s4 as inputs and outputting the prediction value of the processing result data q1 on the premise of the correspondence relationship of the data illustrated in FIG. 2. In the present example, the inputs to the processing result prediction model are the two pieces of input data s2 and s4, and the processing result prediction model is not limited thereto, and may be implemented to receive the five values of the input data s1 to s5 as inputs.

The information processing apparatus 1 stores, in the data storage 12b, the intermediate data acquired from the substrate processing apparatus 101 and the processing result data acquired from the measurement apparatus 102 in association with each other. The information processing apparatus 1 can generate the processing result prediction model by taking the intermediate data stored in the data storage 12b as an input to the processing result prediction model, and performing so-called supervised machine learning with the processing result data associated with the intermediate data as correct values for the output of the processing result prediction model.

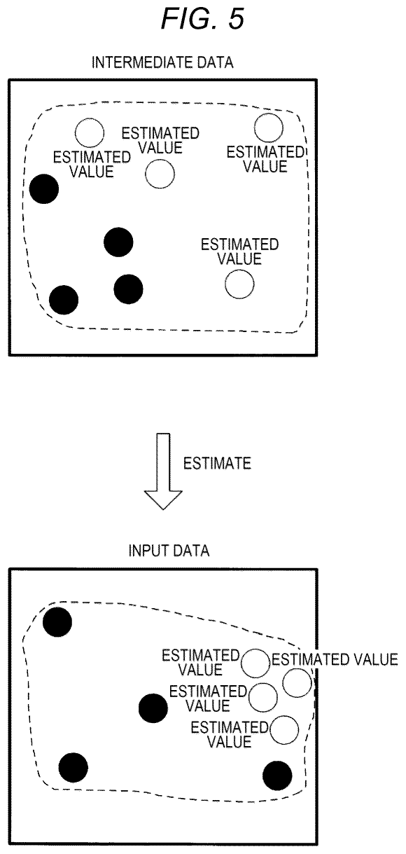

FIG. 5 is a schematic diagram illustrating data estimation. An upper portion of FIG. 5 illustrates a scatter diagram of the correspondence between the intermediate data s2 and s4, and black dots in the drawing correspond to a set of the intermediate data s2 and s4 stored in the data storage 12b (that is, used for the generation of the processing result prediction model), and illustrates a range that can be taken by the intermediate data surrounded by a broken line. In the present example, it is indicated that there is a bias in the acquired intermediate data, and when there is such a data bias, the accuracy of the processing result prediction model may be low. When the prediction accuracy of the processing result prediction model is not sufficient, the user needs to acquire additional data in order to improve the prediction accuracy of the processing result prediction model.

The information processing apparatus 1 searches for a range of data that is not stored in the data storage 12b among the range that can be taken by the intermediate data. In the example of the upper portion of FIG. 5, the acquired intermediate data is biased toward the lower left side of the range, and data on the upper side and the right side of the range is unacquired. The information processing apparatus 1 selects one or a plurality of values from such an unacquired data range to cover, for example, the largest possible range with the smallest possible number of the values, and sets these values as the estimated values of the intermediate data necessary for improving the estimation accuracy. In the example of the upper portion of FIG. 5, four estimated values obtained by the information processing apparatus 1 are indicated by white dots. The information processing apparatus 1 can obtain estimated values of these pieces of intermediate data based on, for example, the design of experiments.

The intermediate data is not a value that can be set directly by the user with respect to the substrate processing apparatus 101. Therefore, the information processing apparatus 1 according to the present embodiment estimates the input data capable of achieving an estimated value of the intermediate data, and presents the input data to the user. A lower portion of FIG. 5 illustrates a scatter diagram of the estimated values of the set of the input data r1 and r2 corresponding to the intermediate data s2, as an example of the estimated values of the input data. In the lower portion of FIG. 5, the black dots correspond to the set of the input data r1 and r2 stored in the data storage 12b, a region surrounded by the broken line is a range in which the input data can be taken, and the white dots correspond to the set of estimated values of the input data r1 and r2 by the information processing apparatus 1. The information processing apparatus 1 estimates four values of the input data r1 to r4, and in the lower portion of FIG. 5, the illustration is simplified to illustrate only two values of the input data r1 and r2, for ease of description.

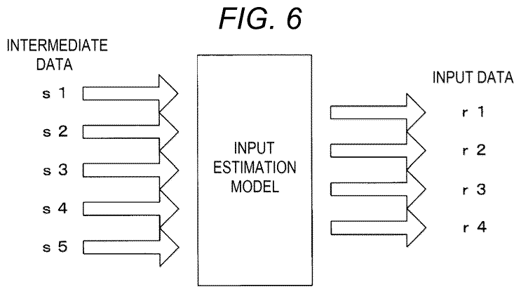

The information processing apparatus 1 according to the embodiment generates the input estimation model based on the input data and the intermediate data stored in the data storage 12b. FIG. 6 is a schematic diagram illustrating an example of a configuration of an input estimation model according to the present embodiment. The illustrated input estimation model is a training model that receives the intermediate data s1 to s5 as inputs and outputs the estimated values of the input data r1 to r4. In the present example, one input estimation model outputs the four values of the input data r1 to r4, and the present embodiment is not limited to the configuration. Four input estimation models that output the respective input data r1 to r4 may be individually generated.

The information processing apparatus 1 stores the input data and the intermediate data acquired from the substrate processing apparatus 101 in the data storage 12b in association with each other. The information processing apparatus 1 can generate an input estimation model by taking the intermediate data stored in the data storage 12b as an input to the input estimation model, and performing so-called supervised machine learning with the input data associated with the intermediate data as a correct value for the output of the input estimation model.

The information processing apparatus 1 can obtain an estimated value of the input data for improving the prediction accuracy of the processing result prediction model by inputting an estimated value of the intermediate data for improving the prediction accuracy of the processing result prediction model into the input estimation model, and acquiring the estimated value of the input data output from the input estimation model. In the present example, the intermediate data s1, s3, and s5 are not related to the processing result data q1 output from the processing result prediction model, and thus there is no estimated value of the intermediate data. In this case, for example, the information processing apparatus 1 may estimate the input data using predetermined fixed values for the intermediate data s1, s3, and s5, or may estimate the input data using random values for the intermediate data s1, s3, and s5, or may use any other appropriate values as the intermediate data s1, s3, and s5.

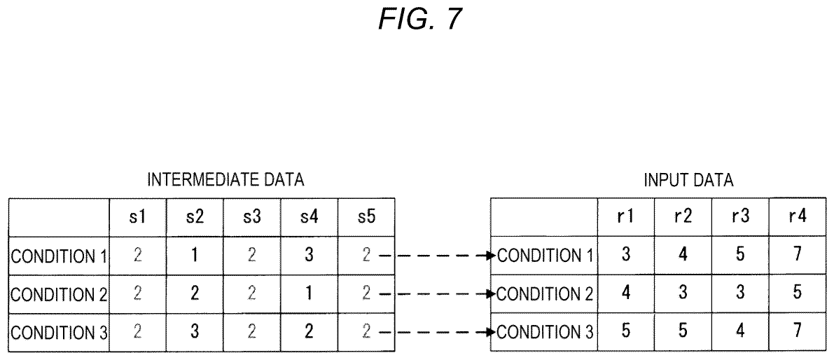

FIG. 7 is a schematic diagram illustrating an example of the estimation results of the intermediate data and the input data. In the present example, the information processing apparatus 1 estimates the three sets of intermediate data s1 to s5 under conditions 1 to 3 as the intermediate data for improving the prediction accuracy of the processing result prediction model based on the design of experiments. In the present example, the intermediate data s1, s3, and s5 do not affect the processing result data q1 predicted by the processing result prediction model, and therefore, a predetermined fixed value “2” is used. The information processing apparatus 1 inputs the estimated intermediate data under conditions 1 to 3 into the input estimation model, and acquires input data under conditions 1 to 3 that are output by the input estimation model, respectively. The information processing apparatus 1 displays information related to the estimated input data on the display 14, and presents the user with three conditions for additionally acquiring data.

The user who is presented the three conditions of the input data by the information processing apparatus 1 operates the substrate processing apparatus 101 under each of the conditions to measure the intermediate data, and measures the result of the substrate processing using the measurement apparatus 102. The information processing apparatus 1 stores the input data, the intermediate data, and the processing result data obtained under the three conditions in the data storage 12b in association with each other, and generates (regenerates) a processing result prediction model using these pieces of data. When the accuracy of the generated processing result prediction model is not sufficient, the user can be expected to obtain a highly accurate processing result prediction model by repeatedly performing the above-described processing to acquire additional data and repeatedly acquiring additional data until sufficient accuracy is obtained.

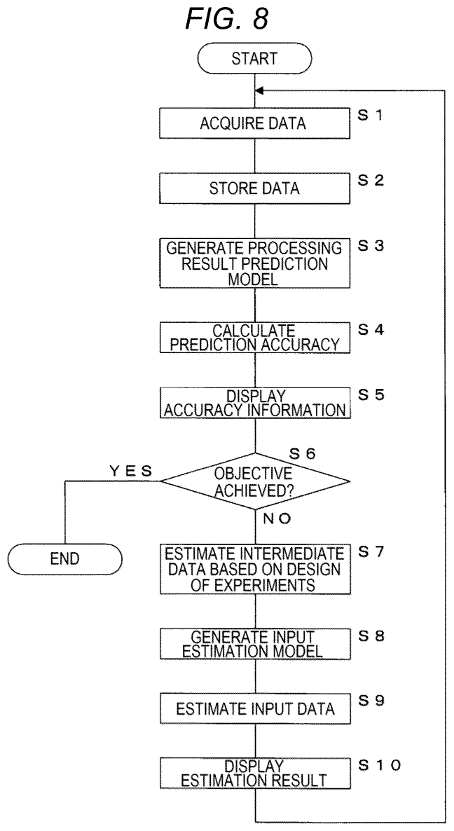

FIG. 8 is a flowchart illustrating an example of a procedure of the data estimation processing performed by the information processing apparatus 1 according to the first embodiment. The data acquisition unit 11a of the processor 11 of the information processing apparatus 1 according to the first embodiment communicates with the substrate processing apparatus 101 and the measurement apparatus 102 via the communication unit 13, thereby acquiring input data input to the substrate processing apparatus 101 (that is, set recipe parameters), intermediate data measured by a sensor during substrate processing, and processing result data obtained by measuring, using the measurement apparatus 102, a result of the substrate processing performed by the substrate processing apparatus 101 (step S1). The data acquisition unit 11a stores the input data, the intermediate data, and the processing result data acquired in step S1 in the data storage 12b in association with each other (step S2).

The model generator 11b of the processor 11 generates, based on the intermediate data and the processing result data stored in the data storage 12b in step S2, a processing result prediction model that receives the intermediate data as an input and outputs a prediction value of the processing result data (step S3). The model generator 11b calculates prediction accuracy with respect to the processing result prediction model generated in step S3, for example, by performing prediction based on the intermediate data stored in the data storage 12b to calculate an error between the processing result data and the intermediate data (step S4). The display processor 11d of the processor 11 displays, on the display 14, the information related to the prediction accuracy of the processing result prediction model calculated in step S4 (step S5).

For example, the processor 11 receives, from the user, a selection related to whether the prediction accuracy of the processing result prediction model achieves the objective with respect to the information display in step S5. Alternatively, the processor 11 may determine whether the prediction accuracy of the generated processing result prediction model achieves the objective based on whether the prediction accuracy calculated in step S4 exceeds a predetermined threshold value. By the appropriate method as described above, the processor 11 determines whether the accuracy of the processing result prediction model achieves the objective (step S6).

When the accuracy of the processing result prediction model does not achieve the objective (S6: NO), the data estimation unit 11c of the processor 11 estimates the intermediate data for improving the accuracy of the processing result prediction model, for example, based on the design of experiments (step S7). The model generator 11b generates, based on the input data and the intermediate data stored in the data storage 12b in step S2, an input estimation model that receives the intermediate data as an input and outputs an estimated value of the input data (step S8). The data estimation unit 11c inputs the intermediate data estimated in step S7 into the input estimation model generated in step S8, and estimates the input data for improving the accuracy of the processing result prediction model by acquiring the estimated value of the input data output by the input estimation model (step S9). The display processor 11d displays the information related to the input data estimated in step S9 on the display 14 (step S10), and returns the processing to step S1.

The user sets, based on the estimated value of the input data displayed on the display of the information processing apparatus 1, the input data to the substrate processing apparatus 101 to perform the substrate processing, and performs a measurement of the intermediate data by the sensors of the substrate processing apparatus 101 and a measurement of the results of substrate processing by the measurement apparatus 102. The information processing apparatus 1 acquires the input data, the intermediate data, and the processing result data related to the additionally performed substrate processing from the substrate processing apparatus 101 and the measurement apparatus 102, and repeats the above-described processing. As a result, when the accuracy of the processing result prediction model achieves the objective (S6: YES), the processor 11 of the information processing apparatus 1 ends the data estimation processing.

### Summary

In the information processing system according to the present embodiment having the configuration described above, the information processing apparatus 1 acquires input data to the substrate processing apparatus 101, intermediate data measured related to the substrate processing performed by the substrate processing apparatus 101 based on the input data, and processing result data measured by the measurement apparatus 102 related to a processing result of the substrate processing. Based on these pieces of acquired data, the information processing apparatus 1 generates a processing result prediction model that receives the intermediate data as an input and outputs a prediction value of the processing result data. For example, when the generated processing result prediction model does not have sufficient prediction accuracy, the information processing apparatus 1 estimates the intermediate data for improving the prediction accuracy of the processing result prediction model, and estimates the input data for obtaining the estimated intermediate data. Accordingly, the information processing system according to the present embodiment can present the estimated input data to the user, cause the user to perform the substrate processing of the substrate processing apparatus 101 based on the input data, and generate a processing result prediction model using the input data, the intermediate data, and the processing result data that are additionally obtained, so that the prediction accuracy of the processing result prediction model can be expected to be improved.

In the information processing system according to the present embodiment, the information processing apparatus 1 generates, based on the acquired input data and the intermediate data, an input estimation model that receives the intermediate data as an input and outputs an estimated value of the input data. The information processing apparatus 1 estimates the input data based on the estimated intermediate data and the generated input estimation model. Accordingly, the information processing system according to the present embodiment can be expected to accurately estimate the input data for obtaining the intermediate data for improving the prediction accuracy of the processing result prediction model.

In the information processing system according to the present embodiment, the information processing apparatus 1 estimates the input data for obtaining the intermediate data for improving the prediction accuracy of the processing result prediction model based on a design of experiments. Accordingly, the information processing system in the present embodiment can be expected to accurately estimate the intermediate data for improving the prediction accuracy of the processing result prediction model.

### Modification Examples

The input data set for the substrate processing apparatus 101, such as the recipe parameter, may have constraints placed on its values, for example, due to the possibility of causing a malfunction in the substrate processing apparatus 101. In the information processing system according to the modification example, the information processing apparatus 1 estimates the input data for improving the prediction accuracy of the processing result prediction model to satisfy the constraints set for the input data.

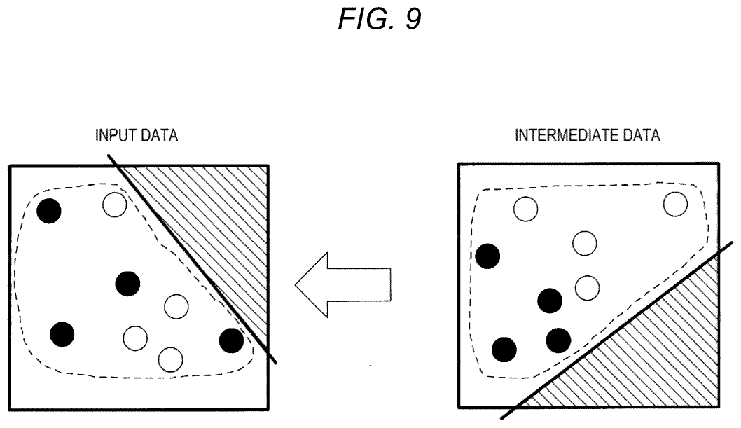

FIG. 9 is a schematic diagram illustrating the data estimation performed by the information processing apparatus 1 according to the modification example. The right side of FIG. 9 illustrates a scatter diagram of the correspondence between the intermediate data s2 and s4, and the black dots in the drawing correspond to a set of the intermediate data s2 and s4 stored in the data storage 12b. The left side of FIG. 9 illustrates a scatter diagram of the estimated values of the set of the input data r1 and r2 corresponding to the intermediate data s2 and s4, as an example of the estimated values of the input data, and the black dots in the drawing correspond to the set of the input data r1 and r2 stored in the data storage 12b, while the white dots correspond to the set of the estimated values of the input data r1 and r2 generated by the information processing apparatus 1. The information processing apparatus 1 estimates four values of the input data r1 to r4, and in FIG. 9, the illustration is simplified to illustrate only two values of the input data r1 and r2, for ease of description.

In the left side of FIG. 9, constraints on the input data are illustrated as hatched regions, and the set of input data r1 and r2 is prohibited from falling within the region. The information processing apparatus 1 acquires the constraints on the input data from the substrate processing apparatus 101 or receives an input from the user. The information processing apparatus 1 determines constraints on the intermediate data based on the constraints on the input data. At this time, the information processing apparatus 1 can determine the constraints on the intermediate data by searching for the intermediate data for which the estimated value of the input data obtained from the input estimation model falls within the prohibited region, using, for example, the input estimation model generated based on the input data and the intermediate data stored in the data storage 12b.

In the right side of FIG. 9, the constraints on the intermediate data are illustrated as hatched regions, and the sets of the intermediate data s2 and s4 are prohibited from falling within the region. When estimating the intermediate data for improving the prediction accuracy of the processing result prediction model based on the design of experiments, the information processing apparatus 1 estimates the intermediate data to satisfy the constraints determined for the intermediate data. Accordingly, the information processing apparatus 1 can be expected to estimate the intermediate data that satisfies the constraints, and estimate the input data that satisfies the constraints based on the intermediate data.

### Second Embodiment

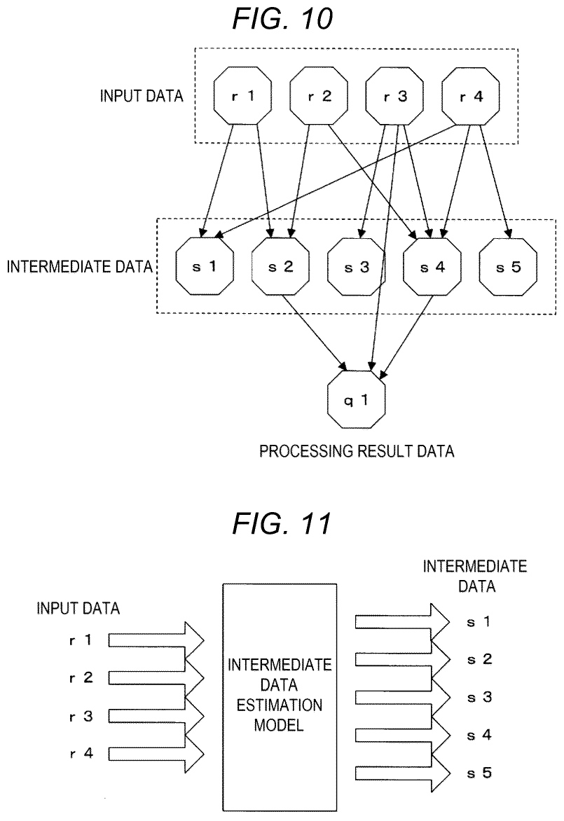

FIG. 10 is a schematic diagram illustrating an example of a correspondence relationship of data acquired by an information processing system according to a second embodiment. As compared with the correspondence relationship of data in the information processing system according to the first embodiment illustrated in FIG. 2, the correspondence relationship of data in the information processing system according to the second embodiment illustrated in FIG. 10 differs in that the processing result data q1 is determined by the intermediate data s2, s4, and also by the input data r3. The information processing system according to the second embodiment deals with a case in which the processing result data is directly affected not only by the intermediate data but also by a part of the input data.

The information processing apparatus 1 according to the second embodiment generates a processing result prediction model that receives the intermediate data and the input data as inputs and outputs prediction values of the processing result data, using the input data (which may be only the input data r3 that directly affects the processing result data q1) stored in the data storage 12b, and the intermediate data (which may be only the intermediate data s2 and s4 that directly affects the processing result data q1), and processing result data corresponding thereto.

The information processing apparatus 1 according to the second embodiment estimates the input data and the intermediate data that improve the prediction accuracy of the processing result prediction model based on a design of experiments. In the case of the example illustrated in FIG. 10, the information processing apparatus 1 estimates the input data r3 and the intermediate data s2 and s4 that improve the prediction accuracy of the processing result prediction model based on the design of experiments, and fixed values, random values, or the like are appropriately set for the intermediate data s1, s3, and s5 that do not directly affect the processing result data q1.

The information processing apparatus 1 according to the second embodiment generates, based on the input data and the intermediate data stored in the data storage 12b, an intermediate data estimation model that receives the input data as an input and outputs an estimated value of the intermediate data. FIG. 11 is a schematic diagram illustrating an example of a configuration of an intermediate data estimation model according to the second embodiment. The illustrated intermediate data estimation model is a training model that receives the input data r1 to r4 as inputs and outputs estimated values of the intermediate data s1 to s5. In the present example, the configuration is such that one intermediate data estimation model outputs the five values of the intermediate data s1 to s5, and the present disclosure is not limited thereto, and the five intermediate data estimation models that output the respective intermediate data s1 to s5 may be individually generated.

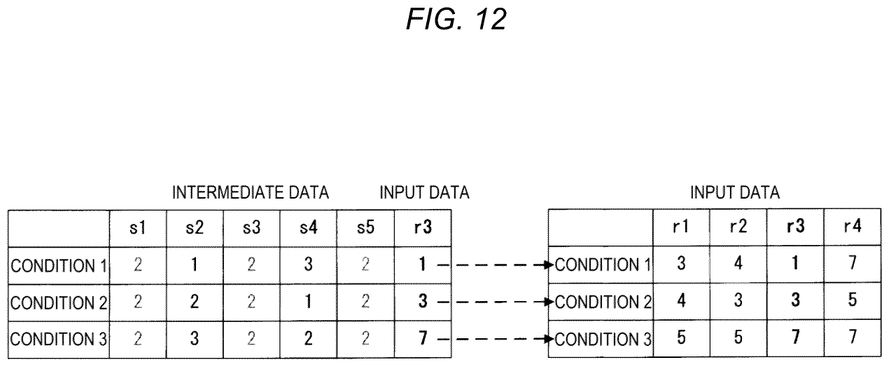

The information processing apparatus 1 according to the second embodiment uses a part of the input data and the intermediate data estimated based on the design of experiments, and the generated intermediate data estimation model, to estimate unestimated remaining input data. FIG. 12 is a schematic diagram illustrating an example of the estimation results of intermediate data and input data in the information processing system according to the second embodiment. In the present example, the information processing apparatus 1 estimates three sets of the intermediate data s2 and s4 and the input data r3 under conditions 1 to 3 as a part of the input data and the intermediate data for improving the prediction accuracy of the processing result prediction model based on the design of experiments. In the present example, the intermediate data s1, s3, and s5 do not affect the processing result data q1 predicted by the processing result prediction model, and therefore, a predetermined fixed value “2” is used.

The information processing apparatus 1 uses the intermediate data s2 and s4, and the input data r3 estimated based on the design of experiments, the intermediate data s1, s3, and s5 appropriately set using the fixed values or the like, and the generated intermediate data estimation model to perform processing for estimating the unestimated input data r1, r2, and r4. In the estimation processing, the input data r3 estimated based on the design of experiments is already estimated, and thus is not included in an estimation target.

The information processing apparatus 1 estimates the input data by searching for optimal input data such that the estimated value of the intermediate data output from the intermediate data estimation model becomes the value of the intermediate data estimated based on the design of experiments. The information processing apparatus 1 can search for the optimal input data for which the output of the intermediate data estimation model becomes a target value, using, for example, a multi-objective optimization method such as Bayesian optimization, a genetic algorithm, or a neural network. The information processing apparatus 1 treats the input data r3 estimated based on the design of experiments as a fixed value in the input to the intermediate data estimation model, and does not treat the input data r3 as a target for multi-objective optimization, or treats the input data r3 as a constraint for fixing the value. Even when the input data r3 does not directly affect the processing result data q1 in the present example (corresponding to the configuration illustrated in FIG. 2 or the like in the first embodiment), the same method can be applied as the multi-objective optimization without the constraint of the fixed value. That is, the multi-objective optimization method described in the second embodiment can also be applied to the configuration illustrated in the first embodiment.

The information processing apparatus 1, which estimates the input data r1, r2, and r4 by the multi-objective optimization processing, inputs the input data r1 to r4 of the estimation result to the intermediate data estimation model, and acquires the estimated value of the intermediate data output by the intermediate data estimation model. The information processing apparatus 1 calculates the reliability based on a difference between the estimated value of the intermediate data acquired from the intermediate data estimation model and the estimated value estimated based on the design of experiments. For example, the differences between the estimated values for the five pieces of intermediate data s1 to s5 can be calculated, and an average value of the calculated five differences can be used as the reliability. In this case, since the smaller the difference is, the higher the reliability is, the information processing apparatus 1 adopts the input data estimated when a reliability value is smaller than a predetermined threshold value, and discards the input data estimated when the reliability value is larger than the threshold value as not being adopted. In the present example, the information processing apparatus 1 estimates three sets of input data under the conditions 1 to 3, calculates the reliability for each of the sets, and determines whether to adopt each set of input data based on a comparison between the calculated reliability and the predetermined threshold value. The information processing apparatus 1 can display information related to the input data determined to be adopted based on the reliability on the display 14 to prompt the user to collect additional data.

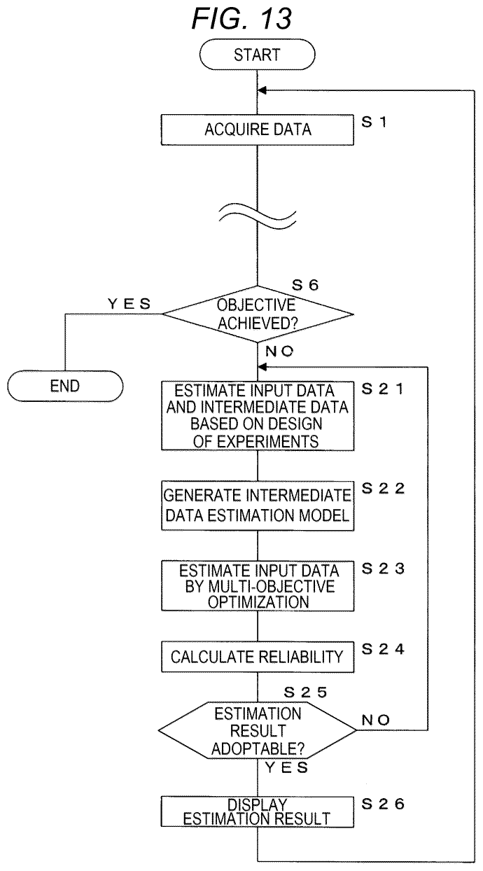

FIG. 13 is a flowchart illustrating an example of a procedure of data estimation processing performed by the information processing apparatus 1 according to the second embodiment. Processing of steps S1 to S6 included in the data estimation processing performed by the information processing apparatus 1 according to the second embodiment are similar to the processing of steps S1 to S6 performed by the information processing apparatus 1 according to the first embodiment illustrated in the flowchart of FIG. 8, and thus the description thereof will be omitted. When the accuracy of the processing result prediction model does not achieve the objective in step S6 (S6: NO), the data estimation unit 11c of the processor 11 estimates a part of the input data (input data that directly affects the processing result data) and the intermediate data that improve the accuracy of the processing result prediction model, based on the design of experiments (step S21).

The model generator 11b of the processor 11 generates, based on the input data and the intermediate data stored in the data storage 12b in step S2, an intermediate data estimation model that receives the input data as an input and outputs an estimated value of the intermediate data (step S22). The data estimation unit 11c estimates optimal input data by the multi-objective optimization method such that the intermediate data estimation model outputs the estimated intermediate data, based on a part of the input data and the intermediate data estimated in step S21, and the intermediate data estimation model generated in step S22 (step S23). The data estimation unit 11c inputs the input data estimated in step S23 into the intermediate data estimation model to acquire an estimated value of the intermediate data, and calculates the reliability of the estimated input data based on a difference between the acquired estimated value of the intermediate data and the estimated value of the intermediate data estimated in step S21 (step S24). The data estimation unit 11c determines whether the estimation result of the input data can be adopted based on the reliability calculated in step S24, for example, based on a comparison result between the reliability and a predetermined threshold value (step S25). When the estimation result of the input data cannot be adopted (S25: NO), the data estimation unit 11c returns the processing to step S21, estimates another piece of data based on the design of experiments, and repeats the same processing. When the estimation result of the input data can be adopted (step S25: YES), the display processor 11d displays information related to the estimation result of the input data on the display 14 (step S26), and returns the processing to step S1.

In the information processing system according to the second embodiment as described above, the information processing apparatus 1 generates a processing result prediction model that receives a part of the data included in the input data and the intermediate data as inputs and outputs the prediction values of the processing result data. The information processing apparatus 1 estimates, based on the design of experiments, a part of the input data and the intermediate data that improve the prediction accuracy of the processing result prediction model. The information processing apparatus 1 generates the intermediate data estimation model that receives the input data as an input and outputs an estimated value of the intermediate data, and estimates the remaining input data that improves the prediction accuracy of the processing result prediction model based on the multi-objective optimization processing using the intermediate data estimation model. Accordingly, the information processing system according to the second embodiment can be expected to accurately estimate the input data that improves the prediction accuracy of the processing result prediction model, even when a part of the input data directly affects the processing result data.

In the information processing system according to the second embodiment, the information processing apparatus 1 estimates a plurality of sets of input data for improving the prediction accuracy of the processing result prediction model. The information processing apparatus 1 calculates the reliability of the estimated input data based on, for example, a difference between the intermediate data estimated using the design of experiments and the intermediate data predicted based on the input data estimated using the multi-objective optimization. The information processing apparatus 1 determines, based on the calculated reliability, whether each of the estimated sets of the input data is acceptable. Accordingly, the information processing system according to the second embodiment can be expected to improve the accuracy of the input data estimation.

### First Modification Example

Similarly to the information processing system according to the modification example of the first embodiment, the information processing system according to a first modification example of the second embodiment estimates input data for improving prediction accuracy of a processing result prediction model in consideration of constraints related to the input data. For example, when the information processing apparatus 1 acquires constraints on input data from the substrate processing apparatus 101 or the user and estimates the input data by the multi-objective optimization method, it can be expected to estimate the input data satisfying the constraints by using the acquired constraints as the constraints for the multi-objective optimization.

### Modification Example 2

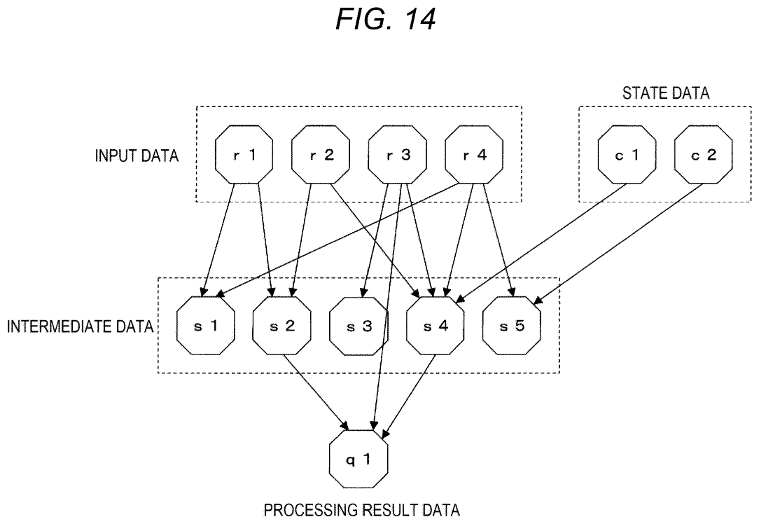

FIG. 14 is a schematic diagram illustrating an example of a correspondence relationship of data acquired by the information processing system according to a second modification example of the second embodiment. As compared with the correspondence relationship of the data in the information processing system according to the second embodiment illustrated in FIG. 10, the correspondence relationship of the data in the information processing system according to the second modification example of the second embodiment illustrated in FIG. 14 newly includes state data as data which is acquired. The state data is, for example, data indicating a state of a component, a consumable, or the like of the substrate processing apparatus 101, and is basically not data in which a user can set any value. The state data is obtained, for example, by measuring a state of a component or the like by a sensor of the substrate processing apparatus 101. Alternatively, for example, the state data may be obtained by the user measuring a component with another measurement apparatus before and after the substrate processing apparatus 101 performs the substrate processing. The information processing apparatus 1 may acquire the state data from the substrate processing apparatus 101 or may acquire the state data by an input from the user.

In the present example, the state data includes two values of c1 and c2. The state data c1 affects the intermediate data s4, and the state data c2 affects the intermediate data s5. The processing result data q1 is indirectly affected by the state data c1 via the intermediate data s4. The state data may include data that directly affects the processing result data q1.

When performing data estimation, the information processing apparatus 1 according to the second modification example of the second embodiment does not treat the state data as a target of estimation, but instead regards the state data as an input of a fixed value and performs estimation of another piece of data. In the present example, although the information processing apparatus 1 first estimates the intermediate data s2 and 24 and the input data r3 based on the design of experiments, since the state data according to the present example does not directly affect the processing result data q1, it is not necessary to consider the state data in the data estimation. When the state data that directly affect the processing result data q1 is included, the information processing apparatus 1 can estimate the data s2 and s4 based on the design of experiments by regarding the state data as fixed input values.

Next, the information processing apparatus 1 estimates the input data r1, r2, and r4 based on the multi-objective optimization method. At this time, the multi-objective optimization is performed by regarding the state data c1 and c2 as the fixed values, similarly to the input data r3.

In the present example, the state data is treated as data that cannot be freely set by the user, and the present disclosure is not limited to the present example, and may be data that can be adjusted to a certain extent by the user performing component replacement or the like. In this case, the information processing apparatus 1 may treat the state data in the same manner as the input data, and may perform data estimation based on the design of experiments, the multi-objective optimization, or the like.

Since the other configurations of the information processing system according to the second embodiment are the same as those of the information processing system according to the first embodiment, the same reference numerals are given to the same locations, and a detailed description thereof will be omitted.

According to the present disclosure, it can be expected to support data collection for improving accuracy of a model for predicting a processing result of a substrate processing apparatus.

The embodiments disclosed herein are exemplary in all respects and can be considered to be not restrictive. The scope of the present disclosure is indicated by the claims, not the above-described meaning, and is intended to include all modifications within the meaning and scope equivalent to the claims.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

Reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The scope of the invention is indicated by the appended claims, rather than the foregoing description.

1. An information processing method comprising:
acquiring, by an information processing apparatus, input data to a substrate processing apparatus, intermediate data measured in relation to substrate processing performed by the substrate processing apparatus based on the input data, and processing result data measured in relation to a processing result of the substrate processing;
generating, by the information processing apparatus, a processing result prediction model to receive the intermediate data as an input and output a prediction value of the processing result data;
estimating, by the information processing apparatus, intermediate data for improving prediction accuracy of the processing result prediction model; and
estimating, by the information processing apparatus, input data for obtaining the estimated intermediate data.

2. The information processing method according to claim 1, wherein
the information processing apparatus estimates the intermediate data for improving the prediction accuracy based on a design of experiments.

3. The information processing method according to claim 1, further comprising:
generating, by the information processing apparatus, an input estimation model to receive the intermediate data as an input and output an estimated value of the input data based on the acquired input data and the intermediate data; and
estimating, by the information processing apparatus, the input data based on the estimated intermediate data and the generated input estimation model.

4. The information processing method according to claim 3, further comprising:
acquiring a constraint on the input data;
determining a constraint on the intermediate data based on the acquired constraint; and
estimating the intermediate data to satisfy the determined constraint.

5. The information processing method according to claim 1, wherein
the processing result prediction model is a model to receive the input data and the intermediate data as inputs and output a prediction value of the processing result data, and
the method further comprises
generating, by the information processing apparatus, an intermediate data estimation model to receive the input data as an input and output an estimated value of the intermediate data, and
estimating, by the information processing apparatus, input data for improving the prediction accuracy of the processing result prediction model based on optimization processing using the generated intermediate data estimation model.

6. The information processing method according to claim 5, further comprising:
estimating, by the information processing apparatus, a plurality of sets of input data for improving the prediction accuracy of the processing result prediction model;
calculating, by the information processing apparatus, reliability for each of the estimated sets; and
determining, by the information processing apparatus, based on the calculated reliability, whether each of the estimated sets is acceptable.

7. The information processing method according to claim 5, further comprising:
acquiring a constraint on the input data; and
estimating the input data by performing the optimization processing to satisfy the acquired constraint.

8. The information processing method according to claim 5, further comprising:
acquiring, by the information processing apparatus, state data of the substrate processing apparatus; and
generating, by the information processing apparatus, the intermediate data estimation model to receive the input data and the state data as inputs and output an estimated value of the intermediate data.

9. A non-transitory computer-readable medium storing executable instructions, which when executed by processing circuitry, cause the processing circuitry to perform a method, the method comprising:
acquiring input data to a substrate processing apparatus, intermediate data measured in relation to substrate processing performed by the substrate processing apparatus based on the input data, and processing result data measured in relation to a processing result of the substrate processing;
generating a processing result prediction model to receive the intermediate data as an input and output a prediction value of the processing result data;
estimating intermediate data for improving prediction accuracy of the processing result prediction model; and
estimating input data for obtaining the estimated intermediate data.

10. An information processing apparatus comprising:
controller circuitry, wherein the controller circuitry is configured to
acquire input data to a substrate processing apparatus, intermediate data measured in relation to substrate processing performed by the substrate processing apparatus based on the input data, and processing result data measured in relation to a processing result of the substrate processing,
generate a processing result prediction model configured to receive the intermediate data as an input and output a prediction value of the processing result data,
estimate intermediate data for improving prediction accuracy of the processing result prediction model, and
estimate input data for obtaining the estimated intermediate data.

11. The information processing method according to claim 1, further comprising:
generating, by the information processing apparatus, an input estimation model to receive the intermediate data as an input and output an estimated value of the input data based on the acquired input data and the intermediate data.

12. The information processing method according to claim 3, further comprising:
acquiring a constraint on the input data; and
determining a constraint on the intermediate data based on the acquired constraint.

13. The information processing method according to claim 1, wherein
the processing result prediction model is a model to receive the input data and the intermediate data as inputs and output a prediction value of the processing result data.

14. The information processing method according to claim 1, wherein
the processing result prediction model is a model to receive the input data and the intermediate data as inputs and output a prediction value of the processing result data, and
the method further comprises
generating, by the information processing apparatus, an intermediate data estimation model to receive the input data as an input and output an estimated value of the intermediate data.

15. The information processing method according to claim 5, further comprising:
estimating, by the information processing apparatus, a plurality of sets of input data for improving the prediction accuracy of the processing result prediction model.

16. The information processing method according to claim 5, further comprising:
estimating, by the information processing apparatus, a plurality of sets of input data for improving the prediction accuracy of the processing result prediction model; and
calculating, by the information processing apparatus, reliability for each of the estimated sets.

17. The information processing method according to claim 5, further comprising:
acquiring a constraint on the input data.

18. The information processing method according to claim 5, further comprising:
acquiring, by the information processing apparatus, state data of the substrate processing apparatus.

19. The information processing apparatus of claim 10, wherein the controller circuitry is configured to estimate the intermediate data for improving the prediction accuracy based on a design of experiments.

20. The information processing apparatus of claim 10, wherein the controller circuitry is configured to:
generate an input estimation model to receive the intermediate data as an input and output an estimated value of the input data based on the acquired input data and the intermediate data; and
estimate the input data based on the estimated intermediate data and the generated input estimation model.
